(19) United States
(12) Patent Application Publication
(10) Pub. No.: US 2010/0172016 A1
(43) Pub. Date: Jul. 8, 2010

(54) Electrophoretic display having high reflectance and contrast

(76) Inventors: Ku Hyun Park, Uiwang-si (KR); O Yong Jeong, Uiwang-si (KR); Kyu Ha Chung, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/654,648

(22) Filed: Dec. 28, 2009

(30) Foreign Application Priority Data
Dec. 29, 2008 (KR) 10-2008-0135840

(51) Int. Cl. G02F 1/167

(52) U.S. Cl. 359/296

(57) ABSTRACT

An electrophoretic display includes a first substrate having a thin film transistor and a pixel electrode, a second substrate disposed to face the first substrate, an electrophoretic membrane interposed between the first and second substrates, and an optical member between the second substrate and the electrophoretic membrane, the optical member being configured to reflect light incident thereon, and a surface of the electrophoretic membrane facing the optical member being conformal to a shape of the optical member.

### BACKGROUND

1. Field

Example embodiments relate to electrophoretic displays (EPDs). More particularly, example embodiments relate to EPDs having high reflectance and contrast.

2. Description of the Related Art

EPDs are image display devices based on a phenomenon wherein oppositely charged colloidal particles are moved between opposite substrates by application of voltage to a pair of electrodes immersed in a colloid solution. For example, EPDs may be applied to electronic papers and the like due to various merits, e.g., no need for a backlight unit, low power consumption, similar display quality as printed matter, low eye fatigue, etc.

In general, an EPD may include a structure having an electrophoretic membrane interposed between two substrates. Pixel electrodes may be formed on a first substrate, such that charged particles in the electrophoretic membrane may move toward the pixel electrodes or away therefrom upon application of voltage to the pixel electrodes. As a result, an image may be displayed on a viewing sheet.

### SUMMARY

Embodiments are directed to an electrophoretic display (EPD), which substantially overcomes one or more of the problems due to the limitations and disadvantages of the related art.

It is therefore a feature of an embodiment to provide an EPD with an optical member to effectively collect light, thereby providing high front reflection characteristics and contrast while improving reflectance.

At least one of the above and other features and advantages may be realized by providing an EPD, including a first substrate having a thin film transistor and a pixel electrode, a second substrate disposed to face the first substrate, an electrophoretic membrane interposed between the first and second substrates, and an optical member between the second substrate and the electrophoretic membrane, the optical member being configured to reflect light incident thereon, and a surface of the electrophoretic membrane facing the optical member being conformal to a shape of the optical member.

The EPD may further include a transparent electrode between the optical member and the electrophoretic membrane.

The optical member may include a micro lens array. Each of the micro lenses in the array may have a ratio (H/R) of height (H) to radius (R) in the range of about 0.2˜1. The micro lens array may be formed to have micro lenses aligned with respective pixels. In one embodiment, one to four micro lenses are aligned with a single pixel.

The optical member may include a lenticular lens. The lenticular lens may have a ratio of height to radius in the range of about 0.2˜1. The lenticular lens may be aligned with a respective pixel. In one embodiment, one or two lenticular lenses are aligned with a single pixel.

The second substrate may have a structure wherein an optical sheet having the optical member formed thereon is stacked on a substrate.

The second substrate may have a structure wherein an optical sheet having the optical member formed thereon is integrally formed with a substrate.

The electrode may be formed only on the first substrate.

The thin film transistor and the pixel electrode may be formed on each pixel defined by a gate line and a data line crossing each other.

The electrophoretic membrane may include a colored pigment particle and a white pigment particle charged with opposite polarities. The colored pigment particle may include a black pigment particle.

Both the colored pigment particle and the white pigment particle may be encapsulated.

The optical member may have a convex lens-shaped surface adjacent to the electrophoretic membrane.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic, exploded side sectional view of an EPD in accordance with an embodiment;

FIG. 2 illustrates a schematic, assembled side sectional view of a EPD in accordance with an embodiment;

FIG. 3 illustrates a diagram of optical characteristics of an EPD in accordance with an embodiment;

FIG. 4 illustrates an optical simulation result of LightTools with respect to an EPD according to a Comparative Example;

FIG. 5 illustrates an optical simulation result of LightTools with respect to an EPD according to Example 1; and

FIG. 6 illustrates a graph comparing reflection characteristics of Examples 1 to 3 with a Comparative Example.

### DETAILED DESCRIPTION

Korean Patent Application No. 10-2008-0135840, filed on Dec. 29, 2008, in the Korean Intellectual Property Office, and entitled: “Electrophoretic Display Having High Reflectance and Contrast,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

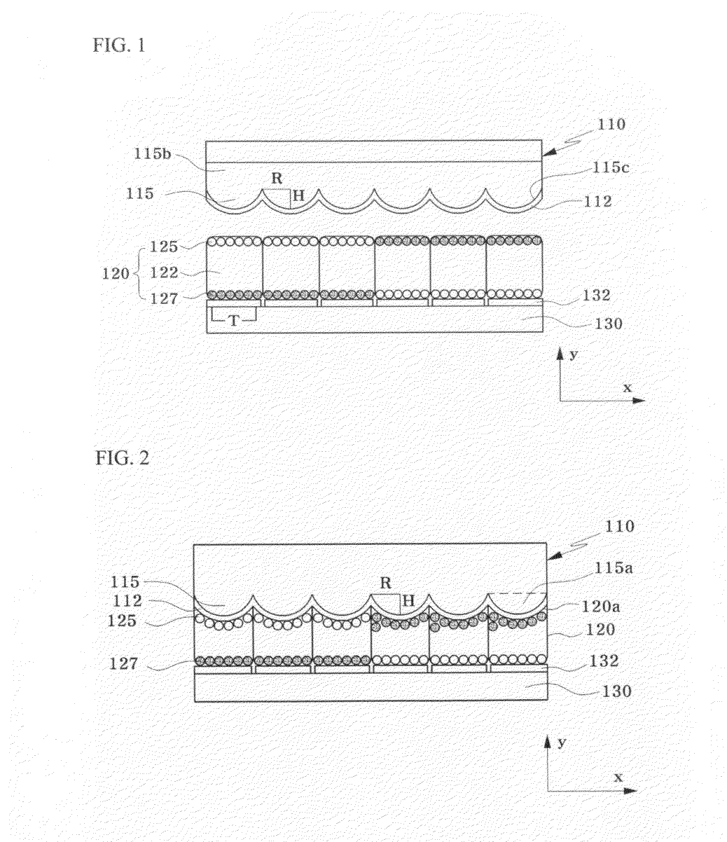

FIG. 1 illustrates a schematic side sectional view of an electrophoretic display (EPD) in accordance with an embodiment, in which a second substrate is separated from an electrophoretic membrane. FIG. 2 illustrates a schematic side sectional view of the EPD in accordance with an embodiment, in which the second substrate is attached to the electrophoretic membrane.

Referring to FIG. 1, an EPD according to an embodiment may include a first substrate 130, a second substrate 110 spaced apart from the first substrate 130, an electrophoretic membrane 120 between the first and second substrates 130 and 110, and an optical member 115 between the second substrate 110 and the electrophoretic membrane 120. Thin film transistors T and pixel electrodes 132 may be formed on the first substrate 130, such that the electrophoretic membrane 120 may be stacked on the pixel electrodes 132. The second substrate 110 may be on a surface of the electrophoretic membrane 120.

The first and second substrates 130 and 110 may be formed of any suitable flexible film. For example, at least one of the first and second substrates 130 and 110 may be transparent in order to display an image in a reflective mode, i.e., where external light is reflected to display the image. For example, the second substrate 110 may be transparent. It is noted, however that other configurations of the first and second substrates 130 and 110, e.g., the first and second substrates 130 and 110 may be formed of a non-flexible material, are included within the scope of the example embodiments.

The thin film transistors T may be formed on the first substrate 130 to correspond to pixels. In other words, the thin film transistor T may be formed at an intersection point between a gate line and a data line that cross each other to define a pixel, and may be connected to the pixel electrode 132 to apply voltage thereto. The thin film transistor T may be formed using any suitable material.

Each of the pixel electrodes 132 may be connected to the thin film transistor T, and may be formed on the first substrate 130. The pixel electrode 132 may be formed of a transparent conductive film, e.g., indium tin oxide (ITO), and may have any suitable shape, e.g., a rectangular or square pattern. Connection between the pixel electrode 132 and the thin film transistors T and configuration thereof may be implemented in any suitable way. For example, the pixel electrodes 132 may be separated from each other, so a thin film transistor T may be formed on a portion of a corresponding pixel electrodes 132. It is noted, however that other configurations of the pixel electrodes 132, e.g., the pixel electrodes 132 may be formed of a high reflectance metal, for example, aluminum, copper, and the like, are included within the scope of the example embodiments.

The electrophoretic membrane 120 may be stacked on the pixel electrodes 132. The electrophoretic membrane 120 may include pigment particles of different colors, e.g., colored pigment particles 127 and white pigment particles 125, which are charged with opposite polarities. For example, the colored pigment particles 127 may include black pigment particles. The colored pigment particles 127 and the white pigment particles 125 may have a particle size of about 1 μm to about 10 μm.

In detail, the electrophoretic membrane 120 may include a solvent in addition to the colored pigment particles 127 and the white pigment particles 125. The colored pigment particles 127 and the white pigment particles 126 may be charged with opposite polarities, and may be dispersed in the solvent. The solvent may be an insulating solvent, and may serve as a dispersion medium for the colored pigment particles 127 and the white pigment particles 125. Examples of the solvent include, but are not limited to, aromatic hydrocarbon, aliphatic hydrocarbon, and silicon oil. For example, the electrophoretic membrane 120 may further include a dispersing agent. In another example, the colored pigment particles 127 and the white pigment particles 125 may be subject to surface treatment to promote dispersion thereof.

The colored pigment particles 127 and the white pigment particles 125 may be contained in microcapsules through encapsulation, e.g., by coacervation. For example, each microcapsule 122 may include colored pigment particles 127 and white pigment particles 126 dispersed in the solvent, thereby forming a dispersion system. For example, each microcapsule 122 may correspond to a respective pixel electrode 132. The microcapsules may be secured to the first and second substrates 130 and 110 by a binder, e.g., via coating or lamination. For example, since the pigment particles are enclosed by a film of the microcapsules in the electrophoretic membrane 120, it may be possible to prevent the pigment particles from moving in undesired directions by a field of an adjacent pixel, thereby realizing improved image quality. The solvent and the binder may be formed of any transparent material to allow transmission of light therethrough.

The optical member 115 in the EPD according to an embodiment may be formed on, e.g., directly on, a surface of the second substrate 110 adjacent to the electrophoretic membrane 120 to guide total reflection of light. For example, as illustrated in FIG. 1, the second substrate 110 and the optical member 115 may be separate elements, so the optical member 115 may be formed by stacking a separate optical sheet on a surface of the second substrate 110 facing the electrophoretic membrane 120. In another example, as illustrated in FIG. 2, the second substrate 110 and the optical member 115 may be integral, so the second substrate 110 may include the optical member 115 integrally formed with the surface thereof.

For example, the optical member 115 may extend along an entire length of the electrophoretic membrane 120, so the optical member 115 and the electrophoretic membrane 120 may overlap, e.g., completely overlap, each other. For example, the optical member 115 may have a convex lens-shaped surface adjacent to the electrophoretic membrane 120. A shape of the optical member 115 may be transferred to a surface of the electrophoretic membrane 120.

For example, if a lower surface 115c of the optical member 115, i.e., a surface facing the electrophoretic membrane 120, is curved, e.g., convex, an upper surface 120a of the electrophoretic membrane 120, i.e., a surface facing the optical member 115, may transform to have a curved shape corresponding conformally, e.g., concavely, to the shape of the lower surface 115c of the optical member 115. That is, referring to FIG. 2, when the second substrate 110 having the optical member 115 is adhered to the upper surface 120a of the electrophoretic membrane 120, the surface shape of the electrophoretic membrane 120 may change to correspond to the shape of the lower surface 115c of the optical member 115. Such a change in the surface shape of the electrophoretic membrane 120 may induce total reflection of incident light. For example, the upper surface 120a of the electrophoretic membrane 120 may be conformal to the lower surface 115c of the optical member 115 along an entire length of the optical member 115. For example, the upper surface 120a may be in direct contact with the lower surface 115c of the optical member 115 along an entire length of the optical member 115. It is noted that the term “conformal” or “conformally” with respect to a shape of a surface describes a surface that is formed along a predetermined profile of another layer or structure to reflect the shape of the predetermined profile, such that the shapes of the conformal surface and the predetermined profile fit as male/female structures.

As further illustrated in FIGS. 1 and 2, a transparent electrode 112 may be formed between the optical member 115 and the electrophoretic membrane 120. However, embodiments may include only pixel electrodes 132 on the first substrate 130, i.e., without a transparent electrode 112 on the second substrate 110.

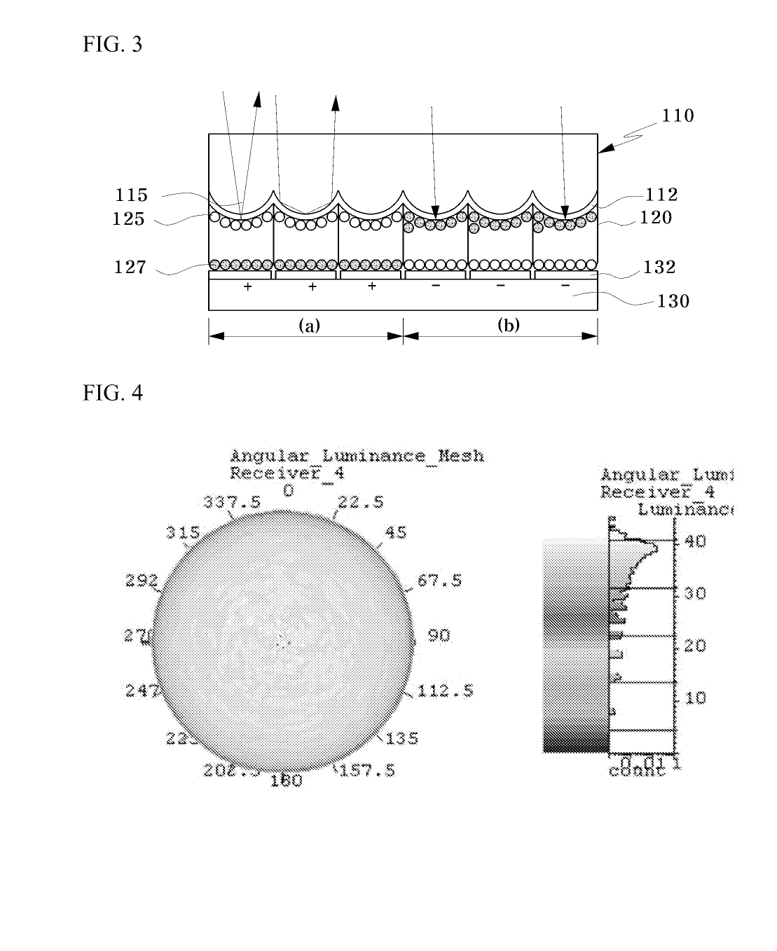

Next, a method of operating an EPD according to an embodiment will be described in more detail with reference to FIG. 3. FIG. 3 illustrates a diagram of optical characteristics of the EPD in accordance with an embodiment.

Referring to FIG. 3(a), the colored and white pigment particles 127 and 125 may be charged with opposite polarities. For example, the colored pigment particles 127 may be charged with a negative (−) polarity, and the white pigment particles 125 may be charged with a positive (+) polarity. Alternatively, the colored pigment particles 127 may be charged with the positive (+) polarity, and the white pigment particles 125 may be charged with the negative (−) polarity.

As illustrated in region (a) of FIG. 3, when a positive (+) voltage is applied to the pixel electrode 132, the negatively charged colored pigment particles 127 may be lowered, i.e., attracted to the pixel electrode 132, while the positively charged white pigment particles 125 may be raised, i.e., repulsed away from the pixel electrode 132 toward the optical member 115. Therefore, when positive (+) voltage is applied to the pixel electrode 132, the white pigment particles 125 may be concentrated on the optical member 115, so that a white (W) image may be observed on the second substrate 110, i.e., an image in a reflective mode may be displayed when external light is reflected to display an image. At this time, as illustrated in region (a) of FIG. 3, part of light incident on an inner lower surface 115c of the optical member 115, e.g., light transmitted through the second substrate 110 and through the optical member 115 to be incident on an interface of the optical member 115 with the transparent electrode 112, may be reflected by total reflection of the optical member 115, thereby providing improved reflection characteristics. As a result, brightness in a white (W) condition may be improved.

On the other hand, as illustrated in region (b) of FIG. 3, when a negative (−) voltage is applied to the pixel electrode 132, the positively charged white pigment particles 125 may be lowered, i.e., attracted to the pixel electrode 132, while the negatively charged colored pigment particles 127 may be raised, i.e., repulsed away from the pixel electrode 132 toward the optical member 115. Therefore, when negative (−) voltage is applied to the pixel electrode 132, colored pigment particles 127 may be concentrated on the optical member 115, so that a black (B) image may be observed on the second substrate 10. At this time, as illustrated in region (b) of FIG. 3, the black particles 127 may be in close contact with the optical member 115 of the second substrate 110, and may absorb, e.g., substantially all, incident light from outside. Therefore, light may not be reflected from the second substrate 110, i.e., total reflection may not be exhibited.

It is noted that a predetermined voltage may be applied to the pixel electrodes 132 to have appropriate distribution of the colored and white pigment particles 127 and 125, so a grey color may be observed at the second substrate 110. In such an operating manner, the positive (+) voltage and the negative (−) voltage may be applied to respective pixel electrodes 132 based on image data. Each of the pixel electrodes 132 may be provided with a respective thin film transistor T to actively adjust the voltage applied to the pixel electrode 132. The polarity of the applied voltage may be controlled for each pixel electrode 132, so that the EPD may display various images.

The EPD may display black and white images through reflection or absorption of external light, as opposed to using a separate light source. Therefore, since the optical member 115 according to example embodiments enhances the brightness in the white (W) condition, e.g., only the brightness in the white (W) condition, while not affecting the black condition (B), i.e., reflection in the black (B) condition may not be exhibited, contrast between the white (W) and black (B) conditions may be improved. In other words, the optical member 115 may be formed on the surface of the second substrate 110 and may exhibit total reflection characteristics, thereby enhancing contrast.

As such the EPD according to example embodiments may provide high front reflection characteristics and contrast by effective collection of light via the optical member 115. In contrast, since a conventional EPD, i.e., an EPD without the optical member 115, may not have sufficient light reflectance in the white (W) mode, e.g., in dark places, the conventional EPD may undergo severe deterioration in display brightness and contrast ratio, e.g., by about ⅓, when displaying non white/black colors via an RGB color filter on an upper side of the first substrate 130 for color display, to the extent that the EPD may not provide a display function.

The optical member 115 may have an optical shape configured to reflect incident light by total reflection. For example, the optical member 150 may include a micro lens array or a lenticular lens structure. Each of the micro lens array or lenticular lens structure may be formed either integrally with or separately from the second substrate 110.

For example, when the optical member 115 includes a micro lens array, a plurality of micro lenses 115a, i.e., separate micro lenses, may be formed on the second substrate 110. For example, as illustrated in FIG. 2, the micro lens array may be formed, such that a single micro lens 115a may be aligned with a respective pixel, e.g., each micro lens 115a and respective pixel electrode 132 may be positioned to completely overlap each other along an x-axis. In another example, the micro lens array may be formed such that four micro lenses may be aligned with a single pixel (not shown). In yet another example, two or three micro lenses may be aligned with a single pixel.

Each of the micro lenses 115a constituting the micro lens array may have a radius of about 10 μm to about 500 μm. This radius range may facilitate formation of the micro lenses 115a, while preventing recognition of the shapes of the micro lenses with the naked eye. The micro lens array may have a fill factor of about 30% to about 100%. The fill factor of the micro lens array in this range may provide improved brightness. In another embodiment, the fill factor may be in the range of about 50% to about 95%. In a further embodiment, the fill factor may be in the range of about 60% to about 90%.

For example, when the optical member 115 includes a lenticular lens structure, a plurality of lenses 115b along the x-axis, i.e., lenses connected to each other along one surface, may be formed on the second substrate 110. For example, as illustrated in FIG. 1, a width of one lens 115b may correspond to, e.g., be aligned with, a width of a single pixel. In another example, the lenticular lens structure may be arranged such that two lenticular lenses may correspond to the width of a single pixel.

The lenses in the micro lens array and in the lenticular lens structure may have a semi-circular shape. For example, each of the micro lenses 115a or each of the lenses 115b may have a ratio (H/R) of height (H) to radius (R) in a range of about 0.2 to about 1 in order to increase a total reflection ratio. If the ratio (H/R) deviates from the above range, the total reflection ratio may be reduced along with deterioration in light collection effect of the optical member 115.

Next, the invention will be described with reference to examples. It should be noted that the following examples are given by way of illustration only and do not limit the scope of the invention.

### Examples

### Example 1

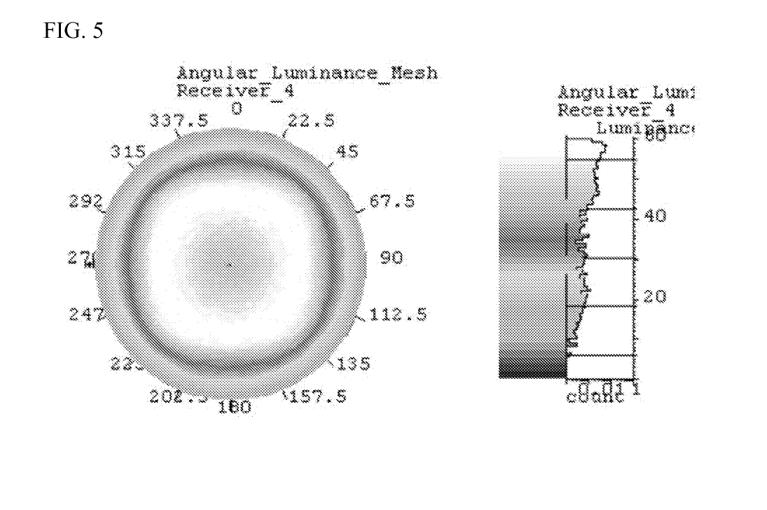

A glass substrate and a PET substrate were prepared as first and second substrates, respectively. An electrophoretic membrane was prepared by dispersing TiO₂ white pigment particles of 1˜10 μm and black pigment particles formed of 1˜10 μm carbon black in a solvent mixture of Toluene and MEK, followed by encapsulation into microcapsules. The microcapsules had a size of 10˜80 μm, and a binder was prepared by polycondensation of urea and formaldehyde. Micro lenses were formed on the second substrate as an optical member and were adhered to an upper side of the electrophoretic membrane. The micro lenses had a radius of 100 μm, a fill factor of 78.5% (right angle alignment structure), and a (H/R) ratio of 1. Reflection characteristics of the prepared EPD were measured using a detector DMS803, and measurement results are shown in FIG. 5. Further, a reflectance (%) depending on an angle is shown in FIG. 6.

### Example 2

An EPD was prepared and tested by the same method as in Example 1, except that the micro lenses had a (H/R) ratio of 0.8. A reflectance (%) depending on an angle is shown in FIG. 6.

### Example 3

An EPD was prepared and tested by the same method as in Example 1, except that the micro lenses had a (H/R) ratio of 0.6. A reflectance (%) depending on an angle is shown in FIG. 6.

### Comparative Example

An EPD was prepared and tested by the same method as in Example 1, except that no optical member was formed on the second substrate. Reflection characteristics of the prepared EPD were measured using a detector DMS803, and measurement results are shown in FIG. 4. Further, a reflectance (%) depending on an angle is shown in FIG. 6.

As shown in FIG. 6, Examples 1 to 3 exhibited better reflection characteristics than the Comparative Example in the range of 0 to 40 degrees. The range of 0˜40 degrees corresponds to an angle range which allows a user to actually see the display devices. Particularly, it can be seen that the reflectance is increased up to near 20% in the range of 20˜40 degrees. Further, since Example 1 exhibits a reflectance of about 60% at about 30 degrees as compared with the Comparative Example, i.e., exhibiting a reflectance of about 40%, it can be seen that the reflectance of Example 1 is about 1.5 times that of Comparative Example. It is considered that such reflectance improvement is a meaningful value capable of compensating for a reduction ratio of brightness resulting from the use of a color filter.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electrophoretic display, comprising:
a first substrate having a thin film transistor and a pixel electrode;
a second substrate disposed to face the first substrate;
an electrophoretic membrane interposed between the first and second substrates; and
an optical member between the second substrate and the electrophoretic membrane, the optical member being configured to reflect light incident thereon, and a surface of the electrophoretic membrane facing the optical member being conformal to a shape of the optical member.

2. The electrophoretic display as claimed in claim 1, further comprising a transparent electrode between the optical member and the electrophoretic membrane.

3. The electrophoretic display as claimed in claim 1, wherein the optical member includes a micro lens array.

4. The electrophoretic display as claimed in claim 3, wherein each micro lens in the micro lens array has a ratio (H/R) of height (H) to radius (R) of about 0.2 to about 1.

5. The electrophoretic display as claimed in claim 4, wherein the micro lens array has a fill factor of about 30% to about 100%.

6. The electrophoretic display as claimed in claim 3, wherein each micro lens in the micro lens array is aligned with a respective pixel.

7. The electrophoretic display as claimed in claim 6, wherein the micro lens array is arranged to have one to four micro lenses aligned with a single pixel.

8. The electrophoretic display as claimed in claim 1, wherein the optical member includes a lenticular lens structure.

9. The electrophoretic display as claimed in claim 8, wherein each lens structure in the lenticular lens structure has a ratio (H/R) of height (H) to radius (R) of about 0.2 to about 1.

10. The electrophoretic display as claimed in claim 8, wherein each lens structure in the lenticular lens structure is aligned with a respective pixel.

11. The electrophoretic display as claimed in claim 10, wherein the lenticular lens structure is arranged to have one to two lenticular lens structures aligned with a single pixel.

12. The electrophoretic display as claimed in claim 1, wherein the optical member is an optical sheet directly on the second substrate, the optical member and the second substrate being separate elements.

13. The electrophoretic display as claimed in claim 1, wherein the optical member and the second substrate are integral.

14. The electrophoretic display as claimed in claim 1, wherein the electrophoretic membrane, the optical member, and the second substrate are directly stacked on each other.

15. The electrophoretic display as claimed in claim 1, wherein one thin film transistor and one pixel electrode correspond to each pixel, the pixel being defined by a gate line and a data line crossing each other.

16. The electrophoretic display as claimed in claim 1, wherein the electrophoretic membrane includes colored pigment particles and white pigment particles charged with opposite polarities.

17. The electrophoretic display as claimed in claim 16, wherein the colored pigment particle include black pigment particles.

18. The electrophoretic display as claimed in claim 16, wherein the colored pigment particle and the white pigment particles are encapsulated.

19. The electrophoretic display as claimed in claim 1, wherein a lower surface of the optical member has a convex lens-shaped surface, the lower surface of the optical member facing the electrophoretic membrane.
